(19) United States
(12) Patent Application Publication
(10) Pub. No.: US 2017/0158467 A1
(43) Pub. Date: Jun. 8, 2017

(54) ROTARY MACHINE WITH ENCODER DIRECTLY CONNECTED TO ROTOR

(71) Applicant: Otis Elevator Company, Farmington, CT (US)

(72) Inventor: Le Lin, Tianjin (CN)

(21) Appl. No.: 15/321,407

(22) PCT Filed: Jul. 2, 2015
(86) PCT No.: PCT/US2015/039102

§ 371 Date: Dec. 22, 2016

(30) Foreign Application Priority Data
Jul. 4, 2014 (CN) 201410315937.8

(51) Int. Cl. B66B 11/04; B66B 11/00; H02K 5/173; H02K 7/10; H02K 11/21; H02K 1/27

(52) U.S. Cl. CPC B66B 11/0438; H02K 11/21; H02K 1/2786; H02K 5/1737; H02K 7/1016; B66B 11/008

(57) ABSTRACT

A rotary machine is provided that includes a housing, a connection plate, a rotor, a bearing, and an encoder. The housing has a housing wall and a housing shaft. The housing shaft extends from the housing wall in an axial direction along a housing shaft centerline. The rotor extends from the connection plate in the axial direction, and extends (e.g., concentrically) about the housing shaft centerline. The bearing supports the rotor on the housing shaft. The bearing enables rotation of the rotor relative to the housing shaft and about the housing shaft centerline. The encoder is positionally fixed relative to the housing shaft. The encoder has an encoder shaft directly connected to the connection plate. The encoder shaft extends in the axial direction and extends concentrically about the housing shaft centerline. The encoder is operable to sense a rotation characteristic of the encoder shaft. The encoder is operable to determine a rotation characteristic of the connection plate based on the rotation characteristic of the encoder shaft.

This application claims priority to Chinese Patent Application Serial No. 201410315937.8 filed Jul. 4, 2014, which is hereby incorporated herein by reference in its entirety.

### BACKGROUND

1. Technical Field

Aspects of the present invention relate to a rotary machine, and more particularly relate to a rotary machine having a rotor and an encoder directly connected to the rotor.

2. Background Information

It is known to provide a rotary machine having a rotor and an encoder that is operable to determine a rotation characteristic (e.g., rotation speed, rotation direction) of the rotor. In some instances, the encoder includes a rotatable encoder shaft that is connected to the rotor via an intermediate shaft and/or a multi-part connection plate. In such instances, the indirect connection between the encoder shaft and the rotor can be susceptible to misalignment and/or mechanical failure, which can cause the encoder to malfunction. Aspects of the present invention are directed to these and other problems.

### SUMMARY OF ASPECTS OF THE INVENTION

According to an aspect of the present invention, a rotary machine is provided. The rotary machine includes a housing, a connection plate, a rotor, a bearing, and an encoder. The housing has a housing wall and a housing shaft. The housing shaft extends from the housing wall in an axial direction along a housing shaft centerline. The rotor extends from the connection plate in the axial direction, and extends concentrically about the housing shaft centerline. The bearing supports the rotor on the housing shaft. The bearing enables rotation of the rotor relative to the housing shaft and about the housing shaft centerline. The encoder is positionally fixed relative to the housing shaft. The encoder has an encoder shaft directly connected to the connection plate. The encoder shaft extends in the axial direction and extends concentrically about the housing shaft centerline. The encoder is operable to sense a rotation characteristic of the encoder shaft. The encoder is operable to determine a rotation characteristic of the connection plated on the rotation characteristic of the encoder shaft

Additionally or alternatively, the present invention may include one or more of the following features individually or in combination:

the housing shaft extends in the axial direction between a first housing shaft end and a second housing shaft end, the first housing shaft end is disposed proximate the housing wall, the second housing shaft end is disposed proximate the connection plate, and the housing shaft forms a housing shaft cavity extending between the first housing shaft end and the second housing shaft end; and

the encoder further includes an encoder body, the encoder body is positionally fixed relative to the housing shaft, the encoder body is disposed at least partially within the housing shaft cavity proximate the second housing shaft end, the encoder shaft extends from the encoder body, and the encoder shaft is rotatable relative to the encoder body;

the encoder is operable to generate a signal indicative of the rotation characteristic of the rotor;

the rotary machine further comprises a control unit, the control unit is operable to receive the signal from the encoder, and the control unit is operable to control a component of the rotary machine in response to the signal;

the connection plate is a disc-shaped unitary structure;

the connection plate is connected to the rotor at a position that is radially outward of the bearing;

the connection plate includes a base portion and a web portion that extends radially outward from the base portion;

the web portion of the connection plate is connected to an end surface of the rotor;

the web portion of the connection plate includes a flange that engages a radially outer portion of the bearing to aid in maintaining an axial alignment of the bearing;

the rotor includes an annular rotor sheave having an annularly-extending sheave groove configured to contact a tension member;

the rotor includes an annular rotor pulley having a first annular portion, a second annular portion, and a web portion, wherein the first annular portion and the second annular portion are separated from one another by a distance that extends in the axial direction, and the web portion extends between the first annular portion and the second annular portion in a radial direction that is at least substantially perpendicular to the axial direction;

a stator disposed relative to the housing and the rotor, wherein the stator includes a stator annulus that extends concentrically about the shaft centerline; and the first annular portion of the rotor pulley is aligned with the stator in the axial direction;

the bearing supports the first annular portion of the rotor pulley on the housing shaft;

a stator disposed relative to the housing and the rotor, wherein the stator includes a stator annulus that extends concentrically about the shaft centerline, the stator annulus defines a plurality of radially extending stator teeth, and the stator includes a plurality of stator coils wrapped around the plurality of stator teeth; and

the rotor includes a plurality of permanent magnets extending circumferentially about the housing shaft centerline, and the plurality of permanent magnets generate a rotor magnetic field operable to interact with the plurality of stator coils;

the rotary machine is configured for use as an electric generator, the rotor magnetic field is operable to cause electric current to flow through the plurality of stator coils when the rotor rotates relative to the housing shaft, and the plurality of stator coils is connected to a power storage device operable to receive and store power generated by electric current flowing through the stator coils;

the rotary machine is configured for use as an electric motor, and the plurality of stator coils are operable to generate a stator magnetic field operable to interact with the rotor magnetic field to cause the rotor to rotate relative to the housing shaft;

the rotary machine is operable to move a tension member in contact with the rotor; and

the tension member is an elevator rope extending between an elevator car and a counterweight, and movement of the tension member by the rotary machine is operable to cause movement of the elevator car and the counterweight.

These and other aspects of the present invention will become apparent in light of the drawings and detailed description provided below.

### BRIEF DESCRIPTION OF THE DRAWINGS

FIG. 1 illustrates a perspective exploded view of a rotary machine.

FIG. 2 illustrates a sectional elevation view of the rotary machine of FIG. 1.

FIG. 3 illustrates a partial sectional perspective view of the encoder and its positioning within the rotary machine of FIG. 1.

FIG. 4 illustrates a partial sectional perspective view of another rotary machine.

FIG. 5 illustrates a partial sectional perspective view of another rotary machine.

FIG. 6 illustrates a partial sectional perspective view of another rotary machine.

### DETAILED DESCRIPTION OF ASPECTS OF THE INVENTION

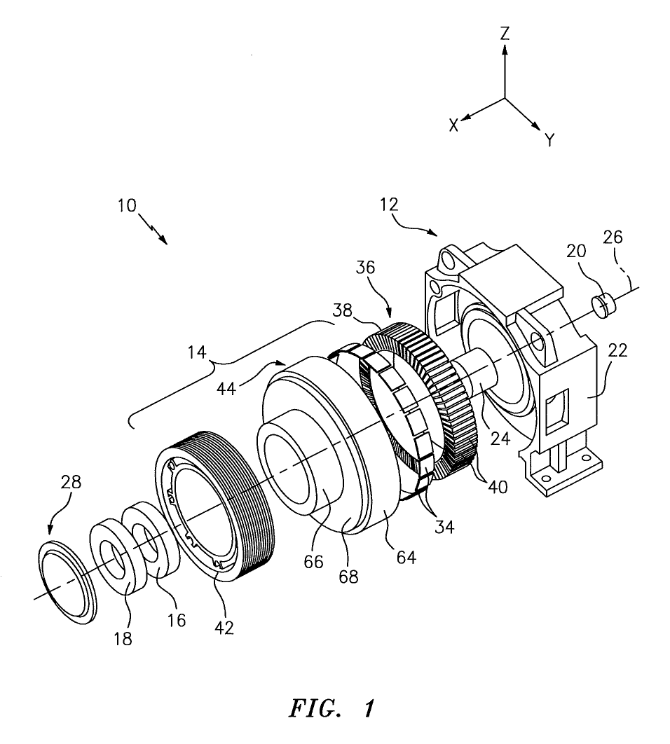

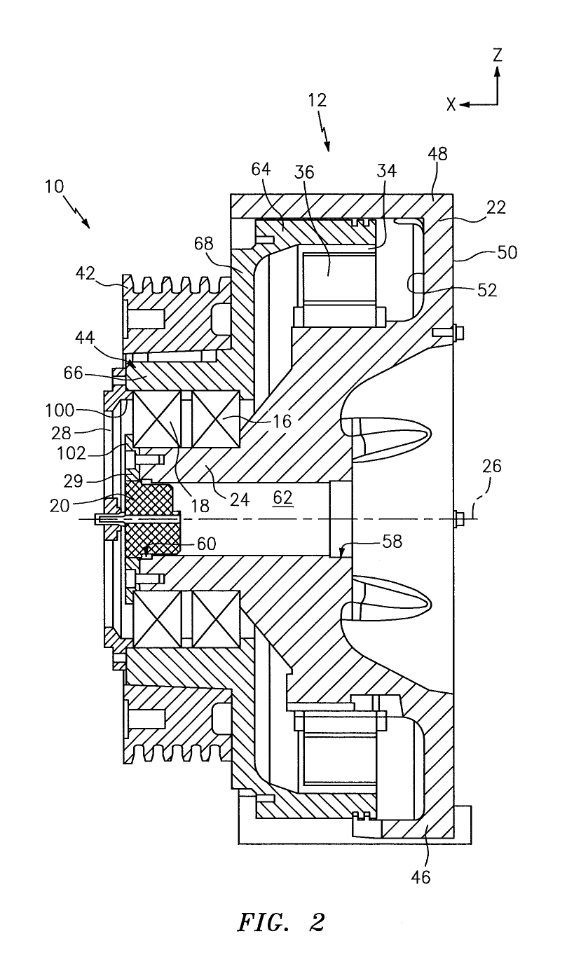

Referring to FIGS. 1 and 2, the present disclosure describes embodiments of a rotary machine 10 in which an encoder 20 is directly connected to a rotor 14 via connection plate 28.

The present disclosure describes aspects of the present invention with reference to the embodiment illustrated in the drawings; however, aspects of the present invention are not limited to the embodiment illustrated in the drawings. The present disclosure may describe one or more features as having a length extending along a x-axis, a width extending along a y-axis, and/or a height extending along a z-axis. The drawings illustrate the respective axes.

The present disclosure uses the terms “circumferential”, “annular”, and variations thereof, to describe one or more features. The term “circumferential”, and variations thereof, are used herein to indicate that a feature extends along a curve that is centered about an axis. The term “annular”, and variations thereof, are used herein to indicate that a feature is at least partially in the form of a ring (e.g., a ring having a circular shape or another shape).

Referring to FIGS. 1 and 2, the rotary machine 10 includes a housing 12, a rotor 14, one or more bearings 16, 18, a connection plate 28, and an encoder 20. In the illustrated embodiments, the rotary machine 10 additionally includes a connection ring 29.

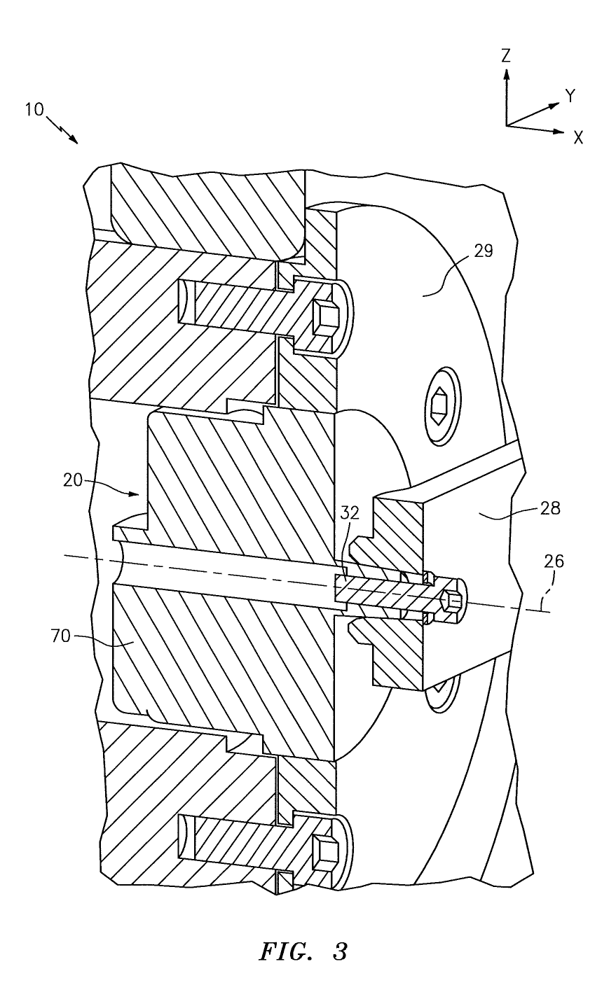

The housing 12 includes a housing wall 22 and a housing shaft 24. The housing shaft 24 extends from the housing wall 22 in an axial direction along a housing shaft centerline 26. The rotor 14 extends from the connection plate 28 in the axial direction, and extends concentrically about the housing shaft centerline 26. The bearings 16, 18 support the rotor 14 on the housing shaft 24, and thereby enable rotation of the rotor 14 relative to the housing shaft 24 about the housing shaft centerline 26. The encoder 20 is positionally fixed relative to the housing shaft 24. The encoder 20 has a rotatable encoder shaft 32 (see FIG. 3). The encoder shaft 32 extends in the axial direction, and extends (e.g., concentrically) about the housing shaft centerline 26. The encoder shaft 32 is directly connected to the connection plate 28. The encoder 20 is operable to sense a rotation characteristic (e.g., rotation speed, rotation direction) of the encoder shaft 32.

The rotary machine 10 can be configured for various different uses. In some embodiments, the rotary machine 10 is configured for use as an electric machine (e.g., an electric generator, an electric motor). Referring to FIGS. 1 and 2, in the illustrated embodiments the rotary machine 10 is configured for use as an elevator system electric motor. As such, the rotary machine 10 additionally includes a stator 36 disposed relative to the housing 12 and the rotor 14. The stator 36 includes a stator annulus 38 that extends concentrically about the housing shaft centerline 26. The stator annulus 38 defines a plurality of radially-extending stator teeth 40. Each of the stator teeth 40 includes a stator coil (not shown) wrapped around it in a known manner. The operation of the rotary machine 10 will be described in more detail below.

Referring to FIG. 2, in the illustrated embodiments the housing wall 22 extends in a heightwise direction between a housing base 46 and a housing top 48. The housing wall 22 extends in a lengthwise direction between a first housing wall surface 50 and a second housing wall surface 52. The housing shaft 24 extends from the second housing wall surface 52. The housing shaft 24 extends in a lengthwise direction between a first housing shaft end 58 and a second housing shaft end 60. The first housing shaft end 58 is disposed proximate the second housing wall surface 52. The second housing shaft end 60 is disposed proximate the connection plate 28. The housing shaft 24 defines a housing shaft cavity 62 that extends in a lengthwise direction between the first and second housing shaft ends 58, 60. The housing shaft cavity 62 is aligned with the housing wall aperture 56.

Referring to FIGS. 1 and 2, in the illustrated embodiments the rotor 14 is segmented into a rotor sheave 42, a rotor pulley 44, and a plurality of permanent magnets 34.

The rotor sheave 42 is an annular structure, and the radially outer surface of the rotor sheave 42 defines a plurality of an annularly-extending sheave grooves, each of which are configured to contact a tension member (e.g., an elevator rope).

The rotor pulley 44 includes a first annular portion 64, a second annular portion 66, and a web portion 68. The first and second annular portions 64, 66 are separated from one another by a lengthwise-extending distance. The web portion 68 extends radially between the first and second annular portions 64, 66. The first annular portion 64 defines a radially inner surface that is configured such that the radially inner surface is separated from the stator 36 by a radially-extending distance. The second annular portion 66 of the rotor pulley 44 defines a radially inner surface that is configured such that the second annular portion 66 can be supported on the housing shaft 24 by the first and second bearings 16, 18.

The permanent magnets 34 extend circumferentially about the housing shaft centerline 26. The permanent magnets 34 are disposed relative to the radially inner surface of the first annular portion 64 of the rotor pulley 44, and thus are axially aligned with the stator 36. The permanent magnets 34 generate a rotor magnetic field, as will be described in more detail below.

Referring to FIGS. 1 and 2, in the illustrated embodiments the rotary machine 10 includes first and second bearings 16, 18 that are separated from one another by a relatively small lengthwise-extending distance. In other embodiments not shown in the drawings, the rotary machine 10 can include only one (1) bearing, or the rotary machine 10 can include more than two (2) bearings. In the illustrated embodiments, the first and second bearings 16, 18 are positioned within a cavity defined by the second annular portion 66 of the rotor pulley 44.

Referring to FIG. 2, in the illustrated embodiments connection plate 28 is a disc-shaped unitary structure. The connection plate 28 includes a base portion and a web portion that extends radially outward from the base portion. The connection plate 28 is connected to the rotor 12 at a position that is radially outward of the first and second bearings 16, 18. In particular, the web portion of the connection plate 28 is connected to an end surface of the second annular portion 66 of the rotor pulley 44. The web portion of the connection plate 28 includes a flange 100 that engages a radially outer portion of the second bearing 18 to aid in maintaining an axial alignment of the first and second bearings 16, 18.

Referring to FIG. 2, in the illustrated embodiments the connection ring 29 is an annular structure that is positioned axially between the connection plate 28 and the housing shaft 24. The connection ring 29 includes an annular base portion and an annular web portion that extends radially outward from the base portion. The base portion of the connection ring 29 includes an aperture through which one or more portions of the encoder 20 extend, as will be described below. The connection ring 29 is connected to the housing 12 at a position that is radially inward of the first and second bearings 16, 18. In particular, the web portion of the connection ring 29 is connected to an end surface of the housing shaft 24. The web portion of the connection ring 29 includes a flange 102 that engages a radially inner portion of the second bearing 18 to aid in maintaining an axial alignment of the first and second bearings 16, 18.

Referring to FIGS. 3-7, in the illustrated embodiments the encoder 20 includes an encoder body 70 and an encoder shaft 32. The encoder shaft 32 extends from the encoder body 70 in a lengthwise direction along the housing shaft centerline 26. The encoder shaft 32 is directly connected to the base portion of the connection plate 28. In some embodiments not shown in the drawings, the encoder shaft 32 is integrally connected to the base portion of the connection plate 28 (i.e., the encoder shaft 32 and the connection plate 28 are a unitary structure).

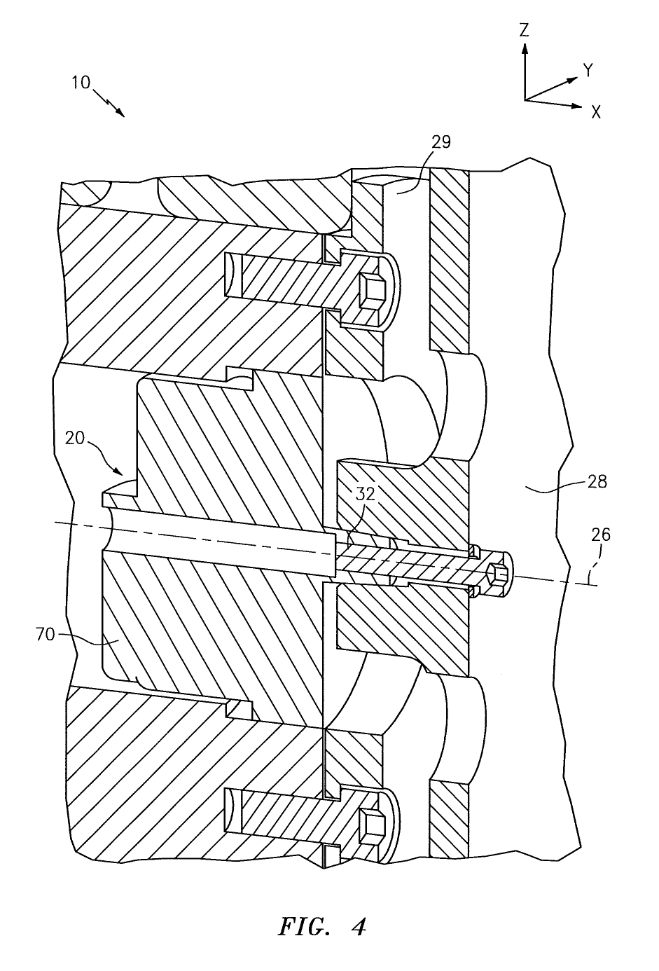

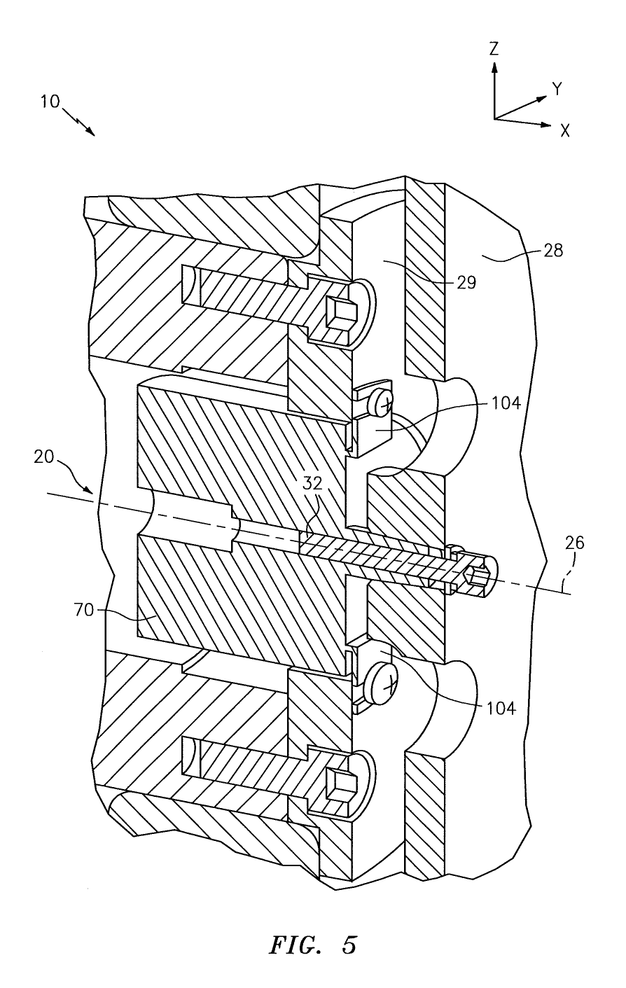

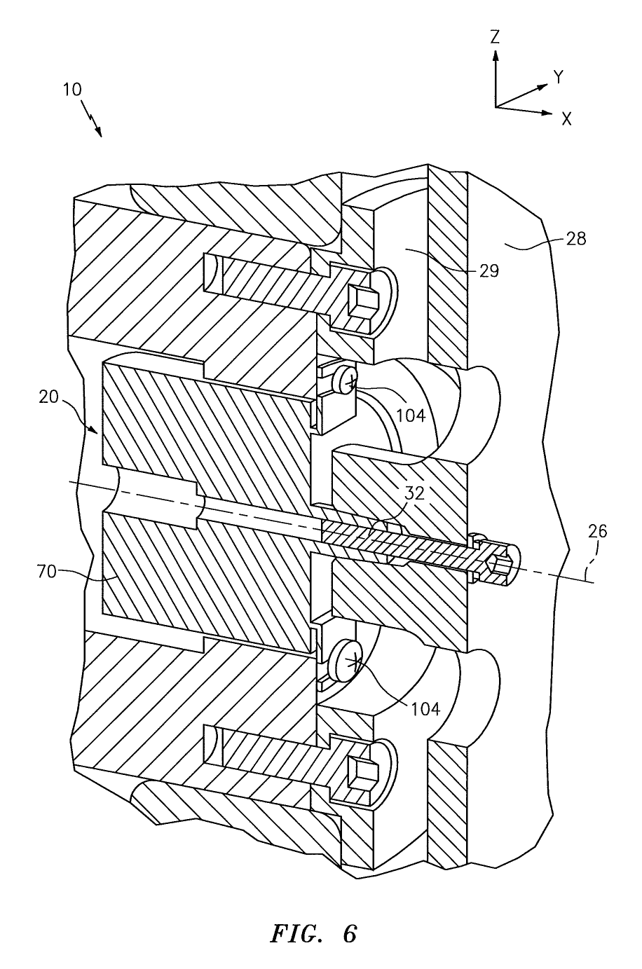

Referring to FIGS. 3-7, in the illustrated embodiments the encoder 20 is positioned relative to the housing 12 such that the encoder shaft 32 extends about the housing shaft centerline 26. The encoder body 70 is disposed at least partially within the housing shaft cavity 62 proximate the second housing shaft end 60. In some embodiments (see FIGS. 3 and 5), a portion of the encoder body 70 extends through the aperture in the base portion of the connection ring 29. In other embodiments (see FIGS. 4 and 6), the encoder body 70 is disposed entirely within the housing shaft cavity 62. In some embodiments (see FIG. 5), the encoder body 70 includes one or more radially-extending flanges 104 that permit connection of the encoder body 70 with the base portion of the connection ring 29. In some embodiments (see FIG. 6), the encoder body 70 includes one or more radially-extending flanges 104 that permit connection of the encoder body 70 with an end surface of the housing shaft 24.

The encoder 20 is operable to sense a rotation characteristic (e.g., rotation speed, rotation direction) of the encoder shaft 32 in a known manner. The encoder 20 is operable to determine a rotation characteristic (e.g., rotation speed, rotation direction) of the rotor 14 based on the rotation characteristic of the encoder shaft 32 in a known manner; and the encoder 20 is operable to generate (e.g., continuously generate, periodically generate) a signal indicative of the rotation characteristic of the rotor 14. The above-described sensing and determining functions of the encoder 20 can be implemented using hardware, software, firmware, or a combination thereof In some embodiments, the encoder 20 can include one or more programmable processors that are operable to perform one or both of the above-described sensing and determining functions. A person having ordinary skill in the art would be able to adapt (e.g., program) the encoder 20 to perform these functions described herein without undue experimentation.

As discussed briefly above, in some embodiments, the rotary machine 10 can be configured for use as an electric machine (e.g., an electric generator, an electric motor). During operation of the rotary machine 10 as an electric generator, the stator coils (not shown) can be electrically connected to a power storage device (not shown) in a known manner. The rotor magnetic field generated by the permanent magnets 34 of the rotor 14 can interact with the stator coils and can cause electric current to flow through the stator coils as the rotor 14 is caused to rotate relative to the housing shaft 24. The stator coils can be connected to a power storage device that receives and stores power generated by the electric current flowing through the stator coils. During operation of the rotary machine 10 as an electric motor, the stator coils can be electrically connected to an alternating current (AC) power supply (e.g., a three-phase AC power supply) in a known manner A stator magnetic field can be generated by the stator as electric current from the AC power supply flows through the stator coils. The stator magnetic field can interact with the rotor magnetic field generated by the permanent magnets 34 of the rotor 14, thereby causing rotation of the rotor 14 relative to the housing shaft 24.

Referring to FIG. 1, during operation of the illustrated rotary machine 10 embodiments, a plurality of elevator ropes (not shown) contact the rotor sheave 42. The elevator ropes extend between an elevator car (not shown) and a counterweight (not shown). The rotor 14 is rotated relative the housing shaft 24, as described above, to move the elevator car and the counterweight within an elevator hoistway (not shown). The encoder 20 continuously generates a signal indicative of the speed and direction of rotation of the rotor 14.

Referring to FIG. 1, in the illustrated embodiments the rotary machine 10 additionally includes a control unit (not shown). The control unit is operable to receive the signal generated by the encoder 20. The control unit is operable to control one or more components of the rotary machine 10 and/or one more other components in response thereto. The control unit is operable to control the speed and direction of rotation of the rotor 14 by controlling a characteristic (e.g., magnitude, polarity) of the electric current flowing from the AC power supply. In some embodiments, the control unit is additionally or alternatively operable to control one or more brake units that are operable to brake (e.g., slow and/or stop movement of) the rotor 14 relative to the housing shaft 24. The functionality of the control unit can be implemented using hardware, software, firmware, or a combination thereof. The control unit can include, for example, one or more programmable processors. A person having ordinary skill in the art would be able to adapt (e.g., program) the control unit to perform the functionality described herein without undue experimentation. Although the control unit is described herein as being separate from the encoder 20, in some embodiments the control unit, or one or more features thereof, can be implemented as a feature of the encoder 20.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A rotary machine, comprising:
a housing having a housing wall and a housing shaft, wherein the housing shaft extends from the housing wall in an axial direction along a housing shaft centerline;
a connection plate;
a rotor extending from the connection plate in the axial direction, and extending concentrically about the housing shaft centerline;
a bearing supporting the rotor on the housing shaft, wherein the bearing enables rotation of the rotor relative to the housing shaft and about the housing shaft centerline;
an encoder positionally fixed relative to the housing shaft, wherein the encoder has an encoder shaft directly connected to the connection plate, the encoder shaft extends in the axial direction and extends about the housing shaft centerline, the encoder is operable to sense a rotation characteristic of the encoder shaft, and the encoder is operable to determine a rotation characteristic of the connection plate based on the rotation characteristic of the encoder shaft.

2. The rotary machine of claim 1, wherein the housing shaft extends in the axial direction between a first housing shaft end and a second housing shaft end, the first housing shaft end is disposed proximate the housing wall, the second housing shaft end is disposed proximate the connection plate, and the housing shaft forms a housing shaft cavity extending between the first housing shaft end and the second housing shaft end; and
wherein the encoder further includes an encoder body, the encoder body is positionally fixed relative to the housing shaft, the encoder body is disposed at least partially within the housing shaft cavity proximate the second housing shaft end, the encoder shaft extends from the encoder body, and the encoder shaft is rotatable relative to the encoder body.

3. The rotary machine of claim 1, wherein the encoder is operable to generate a signal indicative of the rotation characteristic of the rotor.

4. The rotary machine of claim 3, wherein the rotary machine further comprises a control unit, the control unit is operable to receive the signal from the encoder, and the control unit is operable to control a component of the rotary machine in response to the signal.

5. The rotary machine of claim 1, wherein the connection plate is a disc-shaped unitary structure.

6. The rotary machine of claim 1, wherein the connection plate is connected to the rotor at a position that is radially outward of the bearing.

7. The rotary machine of claim 6, wherein the connection plate includes a base portion and a web portion that extends radially outward from the base portion;
wherein the web portion of the connection plate is connected to an end surface of the rotor.

8. The rotary machine of claim 7, wherein the web portion of the connection plate includes a flange that engages a radially outer portion of the bearing to aid in maintaining an axial alignment of the bearing.

9. The rotary machine of claim 1, wherein the rotor includes an annular rotor sheave having an annularly-extending sheave groove configured to contact a tension member.

10. The rotary machine of claim 1, wherein the rotor includes an annular rotor pulley having a first annular portion, a second annular portion, and a web portion, wherein the first annular portion and the second annular portion are separated from one another by a distance that extends in the axial direction, and the web portion extends between the first annular portion and the second annular portion in a radial direction that is at least substantially perpendicular to the axial direction.

11. The rotary machine of claim 1, further comprising a stator disposed relative to the housing and the rotor, wherein the stator includes a stator annulus that extends concentrically about the shaft centerline; and
wherein the first annular portion of the rotor pulley is aligned with the stator in the axial direction.

12. The rotary machine of claim 1, wherein the bearing supports the first annular portion of the rotor pulley on the housing shaft.

13. The rotary machine of claim 1, further comprising a stator disposed relative to the housing and the rotor, wherein the stator includes a stator annulus that extends concentrically about the shaft centerline, the stator annulus defines a plurality of radially extending stator teeth, and the stator includes a plurality of stator coils wrapped around the plurality of stator teeth; and
wherein the rotor includes a plurality of permanent magnets extending circumferentially about the housing shaft centerline, and the plurality of permanent magnets generate a rotor magnetic field operable to interact with the plurality of stator coils.

14. The rotary machine of claim 13, wherein the rotary machine is configured for use as an electric generator, the rotor magnetic field is operable to cause electric current to flow through the plurality of stator coils when the rotor rotates relative to the housing shaft, and the plurality of stator coils is connected to a power storage device operable to receive and store power generated by electric current flowing through the stator coils.

15. The rotary machine of claim 13, wherein the rotary machine is configured for use as an electric motor, and the plurality of stator coils are operable to generate a stator magnetic field operable to interact with the rotor magnetic field to cause the rotor to rotate relative to the housing shaft.

16. The rotary machine of claim 1, wherein the rotary machine is operable to move a tension member in contact with the rotor.

17. The rotary machine of claim 16, wherein the tension member is an elevator rope extending between an elevator car and a counterweight, and movement of the tension member by the rotary machine is operable to cause movement of the elevator car and the counterweight.
